(19) United States
(12) Patent Application Publication
(10) Pub. No.: US 2021/0332925 A1
(43) Pub. Date: Oct. 28, 2021

(54) TAP AND PLUG TOOL FOR SEALING POLYETHYLENE PIPING TAPPING TEE HOLES

(71) Applicant: Consolidated Edison Company of New York, Inc., New York, NY (US)

(72) Inventor: Richard J. Trieste, JR., Staten Island, NY (US)

(21) Appl. No.: 16/860,203

(22) Filed: Apr. 28, 2020

(51) Int. Cl. F16L 41/04; F16L 55/11

(52) U.S. Cl. CPC F16L 41/04; F16L 55/11

(57) ABSTRACT

According to one aspect of the invention, a tool and a method of sealing a hole in a pipe is provided. The tool includes a first portion configured to form a first thread in the hole. A second portion adjacent the first portion is provided having a second thread, the second thread configured to engage the first thread. A third portion adjacent the second portion is provided opposite the first portion. The third portion being sized larger than the hole and having a feature configured to engage an installation tool. A seal is arranged between the third portion and the pipe when the tool is installed in the hole.

### BACKGROUND

The subject matter disclosed herein relates to plugging and sealing gas piping systems, such as holes created by the removal of tee fittings on natural gas distribution systems.

Typically, gas is distributed through pipes usually referred to as “gas mains.” These gas main pipes are larger in diameter to allow sufficient volume of gas to flow at a desired pressure. The gas main pipes are typically made from a plastic material, such as polyethylene.

Natural gas delivery systems, such as those that deliver gas to a residential or commercial building, utilize pipes that are connected to the building and this pipe can be referred to as a service lateral or “service” via a valve, such as a wing cock valve, and a meter. Typically, the pipe is mostly disposed underground and rise to the surface adjacent the where the pipe is to enter the building. The service is connected to the gas main using a self-tapping fitting that is sometimes referred to as tee connection 100 as shown in FIG. 1 and FIG. 2.

The tee connection 100 comprises a main body 102 having an end 104 shaped to conform with the outside diameter of the gas main 106. On an opposite end 108, a cap 110 is removably coupled to the body. Extending from a side of the body 102 is a connection pipe 112. The connection pipe 112 is connected to a pipe that delivers gas from the gas main 106. A cutter 114 is provided that is sized to fit within the interior of the body 102.

The tee connection 100 to gas main 106 for plastic pipes is sometimes made by a plastic joining process called fusion. Fusions for tees are made by heating tee connection end 104 and the corresponding outside wall of gas pipe 106 where the end 104 of tee connection 100 is to be installed. The joining process creates a pressure joint called a fusion bead 105 that is 360 degrees circumferential around end 104. It should be appreciated that the illustrated fusion bead has a saddle shape, however the fusion bead may have different shapes, including no base or a square base.

The cutter 114 serves as both a plug to allow on/off control of the gas through the tee connection 100, and also serves as a means for cutting a smooth bore hole in the gas main 106. The hole made by the cutter 114 allows the gas to flow from the gas main 106 to the connection pipe 112. The cutter 114 makes a smooth bore hole in the wall of the gas main 106.

Sometimes the tee connection 100 has to be removed from the gas main 106. This can be difficult, particularly when the gas main is under a pressurized condition. Generally, gas utilities will only remove the tee connection 100 in a pressurized system when the pressure is low (e.g. less than 12″ water column). When the gas pressure in the gas main 106 is higher than the desired threshold pressure to work on a pipe with blowing gas, the utility will shut off gas flow to the gas main 106 to remove tee connection 100 and plug or seal the hole in the gas main 106. It should be appreciated that this may be expensive, and result in lost revenue for the gas utility and an inconvenience for their customers.

While existing systems and the methods for removing a tee connection from a gas main are suitable for their intended purposes a need for improvement remains, particularly in providing a plug and seal arrangement that may be used when the gas main is pressurized and fusion bead 105 is abandoned in place.

### BRIEF DESCRIPTION

According to one aspect of the disclosure, a tool and a method of sealing a hole in a pipe is provided. The tool includes a first portion configured to form a first thread in the hole. A second portion adjacent the first portion is provided having a second thread, the second thread configured to engage the first thread. A third portion adjacent the second portion is provided opposite the first portion. The third portion being sized larger than the hole and having a feature configured to engage an installation tool. A seal is arranged between the third portion and the pipe when the tool is installed in the hole.

According to another aspect of the disclosure, a method for removing a tee connection from a gas pipe is provided where the tee connection has a cutter element. The method includes removing the cutter element to expose a hole in the gas pipe. A tool is inserted into the hole, the tool having a first portion configured to form a first thread in the hole, a second portion adjacent the first portion having a second thread, the second thread configured to engage the first thread, a third portion adjacent the second portion opposite the first portion, the third portion being sized larger than the hole and having a feature configured to engage an installation tool, and a seal arranged between the third portion and the pipe when the tool is installed in the hole. The tool is rotated to form the first thread. The tool is rotated to engage the first thread with the second thread. The seal engages between the third portion and an outer surface of the pipe to prevent fluid communication between the gas pipe and the environment.

According to another aspect of the disclosure, a tool for sealing a hole in a pipe is provided. The tool includes a tap portion having a plurality of flutes each of the flutes having a feature for forming a first thread in the hole. A threaded portion is integral with and extending from the tap portion, the threaded portion having a second thread, the second thread configured to engage the first thread. A head portion extends from and is integral with the threaded portion opposite the tap portion, the head portion having an outer diameter that is larger than the hole and having a feature configured to engage an installation tool. A seal is arranged between the head portion and the pipe when the tool is installed in the hole.

These and other advantages and features will become more apparent from the following description taken in conjunction with the drawings.

### BRIEF DESCRIPTION OF THE DRAWINGS

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a perspective view of a portion of a prior art gas main with a tee connection;

FIG. 2 is a partially unassembled view of a prior art tee connection;

FIG. 3 is schematic view of a underground gas system in accordance with an embodiment;

FIG. 4 is a side view of a tool for plugging a hole in gas main when a tee connection is removed in accordance with an embodiment;

FIG. 5 is a partial perspective view of a bottom of the tool of FIG. 4 in accordance with an embodiment; and

FIG. 6 is a partial perspective view of a top of tool FIG. 4 in accordance with an embodiment; and

FIG. 7 is a side view partially in section of the tool of FIG. 4 installed in a gas main according to an embodiment.

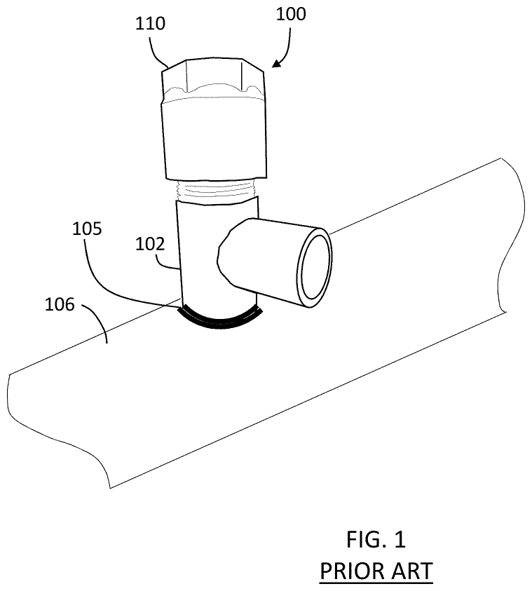

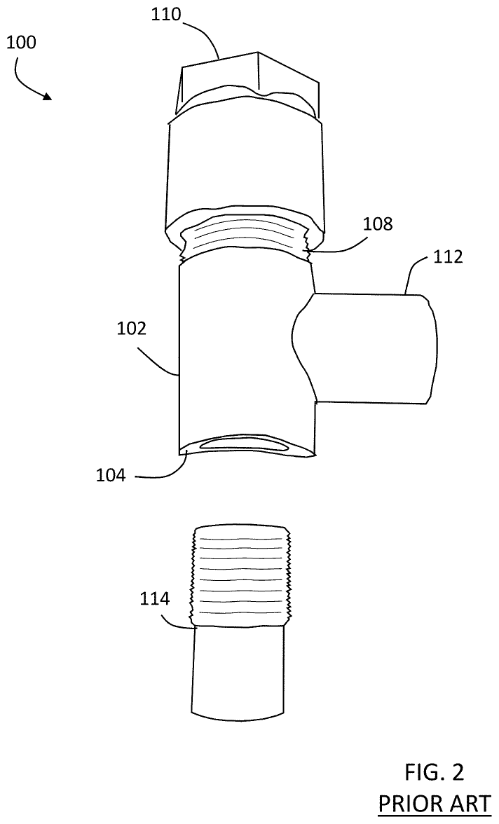

The detailed description explains embodiments of the invention, together with advantages and features, by way of example with reference to the drawings.

### DETAILED DESCRIPTION

Embodiments of the present disclosure provide advantages in performing maintenance and repairs on gas pipes, such as those used in the delivery of natural gas. Further embodiments of the present disclosure provide advantages in allowing a hole in a gas pipe to be plugged and sealed when the gas pipe is pressurized.

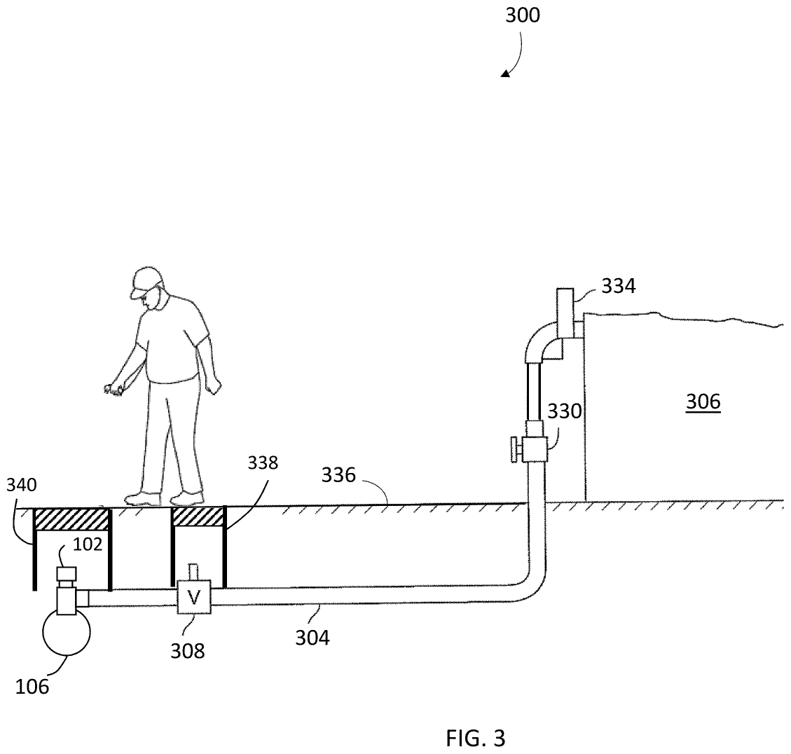

Referring to FIG. 3, an embodiment is shown of a gas delivery system 300. The gas system 300 includes a main gas pipe 106 which includes one or more services or branch pipes 304 that connect the main gas pipe 106 to a consumer 306, such as a residential house for example or another gas pipe same as pipe 106. The system 300 may include a number of valves 308, 330 that control the flow of gas, such as natural gas for example, to the consumer 306. The amount of gas used by the consumer 306 is measured by a meter 334.

Some of the valves, such as valve 308, and connections, such as tee connection 100 may be disposed below ground level 336. It should be appreciated that while the illustrated embodiment shows the underground valve 308 as being to the branch pipe 304 (sometimes referred to as a curb valve), this is for exemplary purposes and the claims should not be so limited and underground valves may be located on the main gas pipe 106. In some instances, to access these subterranean valves, an access structure is provided, such as the valve box 338 for example. In an embodiment, the tee connection 100 may be accessed by a structure 340 similar to box 338. It should be appreciated that in some embodiments, tee connection 100 may be buried with no direct access from the surface.

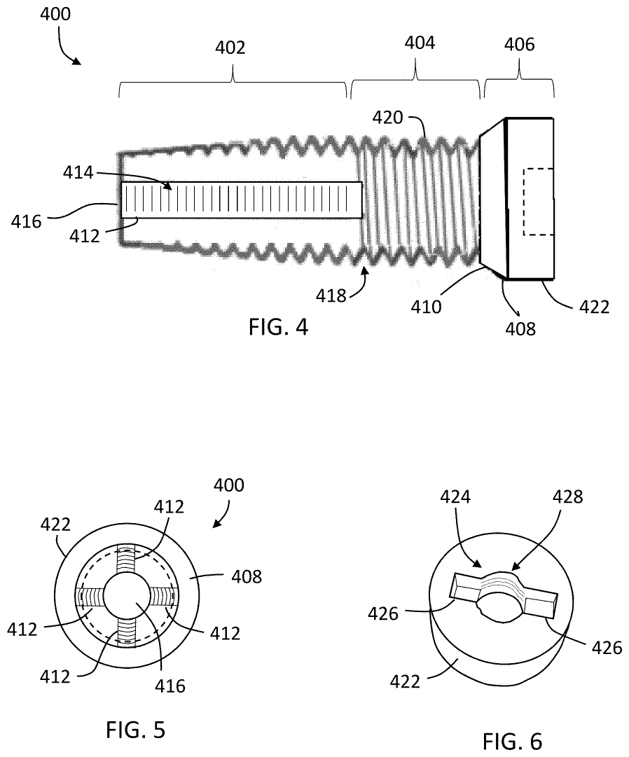

Referring now to FIG. 4 and FIG. 5, an embodiment is shown of a tool 400 for plugging and sealing a hole in the gas main pipe 106 to allow tee connection 100 to be removed. In an embodiment, the tool 400 includes a first portion 402, a second portion 404, and a third portion 406. In the illustrated embodiment, the first portion 402, second portion 404, and third portion 406 are integrally formed. In other embodiments, the portions 402, 404, 406 may be separately formed and coupled together. The tool 400 further includes a seal 408 disposed on the third portion 406. In the illustrated embodiment, the seal 408 has a conical surface 410.

In the illustrated embodiment, the first portion 402 includes a plurality of tapered walls or flutes 412. Each of the flutes 412 has an outer surface having thread or tooth profiles 414 formed therein. As will be discussed in more detail herein, the thread or tooth profiles 414 cut or form a thread in the smooth bore hole formed by the cutter 114 in the gas pipe 106. In other words, the first portion 402 forms a taper tap that gradually forms a thread in the gas pipe 106. Further, the thread or tooth profile 414 is the same as that formed on the second portion 404. In the illustrated embodiments the flutes have a curved outer end having a first diameter at the first portion first end 416 and a second diameter at a first portion second end 418. In an embodiment, the first end 416 is the same size as or is smaller than the hole in the pipe that it is going to be installed. It should be appreciated that while a tapered tap type of thread forming structure is shown, other types of taps may be used such as but not limited to a bottoming tape, a forming tap, or plug tap for example.

In the illustrated embodiment, the second portion 404 includes a threaded outer diameter 420. The thread 420 formed in the outer diameter is sized to engage the threads formed by the first portion 402 in the side wall of the gas pipe 106 when the tool 400 is installed in the gas pipe 106. The second portion 404 has a length sufficient to fully engage the thread formed in the gas pipe 106. In some embodiments, the second portion 404 has a length that is longer than the thickness of a sidewall of the pipe it is being installed.

In the illustrated embodiment, the third portion 406 includes a cylindrical head 422 that extends from and is integral with the second portion 404. In an embodiment, the head 422 includes an engagement feature 424 that allows an installation tool (such as a T wrench for example, not shown) used by the operator to rotate the tool 400 when it is installed in the gas pipe 106. In an embodiment, the engagement feature 424 includes a pair of opposing slots 426 and/or a threaded center hole 428. In other embodiments, the engagement feature may be an external element, such having a pair of flat surfaces suitable to engage a wrench (e.g. a hexagonal nut).

In an embodiment, the seal 408 is positioned over the second portion 404 and against the head 422. The seal 408 may be made from an elastomeric material or other materials having a suitable durometer to form a pressure seal between the surface of the gas pipe 106 and the tool 400.

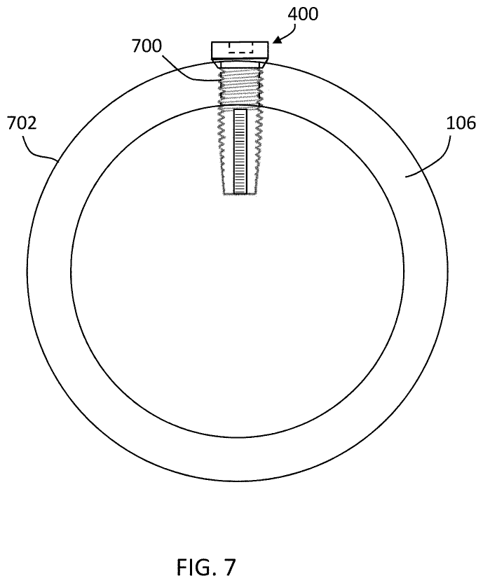

In reference to FIG. 7, during operation the operator begins by removing the cap 110 from the tee connection 100. This allows the operator access to the cutter 114. In an embodiment, operator uses a removal tool to remove the cutter 114 through the interior of the body 102. with the cutter 114 removed from the gas pipe 106, the tool 400 is placed into the hole 700 in the gas pipe that previously fluidly connected the gas pipe 106 to the tee connection 100. The tool 400 is inserted until the tapered outer end of the first portion engages the outside edge of the hole 700 in the gas pipe 106. The operator then rotates the tool 400 causing the thread or tooth profile to engage and cut into the inner surface of the hole 700. In the illustrated embodiment, the cutting of the thread in the hole 700 continues until a fully formed thread is cut in the inner surface of the hole 700.

The operator continues to rotate the tool 400 causing the threads 420 on the second portion 404 to engage the threads formed in the hole 700 by the first portion 402. The rotation of the tool 400 continues until the surface 410 of seal 408 engages the outer surface 702 of the pipe 106. In an embodiment, the seal 408 is compressed between the head 422 and the outer surface 702. The engagement of the seal 408 forms a pressure tight seal to prevent gas within the pipe 106 from leaking into the environment. It should be appreciated that the tool 400 provides advantages and allows the gas pipe to be tapped, threaded and sealed in a single step. With the tee connection 100 removed, additional repairs may be made to the gas pipe 106 such as by removing tee connection 100 and installing a sleeve (not shown) over the tool 400.

It should be appreciated that the removal of the tee connection and the installation of the tool 400 may be done rapidly which provides advantages in allowing the removal tee connection and sealing of the gas pipe even with the gas pipe under normal operating conditions (e.g. greater than 12″ w.c.).

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A tool for sealing a hole in a pipe, the tool comprising:
a first portion configured to form a first thread in the hole;
a second portion adjacent the first portion having a second thread, the second thread configured to engage the first thread;
a third portion adjacent the second portion opposite the first portion, the third portion being sized larger than the hole and having a feature configured to engage an installation tool; and
a seal arranged between the third portion and the pipe when the tool is installed in the hole.

2. The tool of claim 1, wherein the first portion includes a plurality of flutes, each of the flutes having a feature configured to form the first thread.

3. The tool of claim 2, wherein each of the flutes tapers from a first end to a second end, the second end being adjacent the second portion.

4. The tool of claim 3, wherein the second portion has a length that is longer than a thickness of a sidewall of the pipe.

5. The tool of claim 1, wherein the seal is shaped to engage the third portion.

6. The tool of claim 5, wherein the shape is a conical shape.

7. The tool of claim 5, wherein the seal is made from an elastomeric material.

8. The tool of claim 1, wherein the feature includes at least one of a slot, a threaded hole and at least a pair of flat surfaces.

9. A method of removing a tee connection from a gas pipe, the tee connection having a cutter element, the method comprising:
removing the cutter element to expose a hole in the gas pipe;
inserting a tool into the hole, the tool having a first portion configured to form a first thread in the hole, a second portion adjacent the first portion having a second thread, the second thread configured to engage the first thread, a third portion adjacent the second portion opposite the first portion, the third portion being sized larger than the hole and having a feature configured to engage an installation tool, and a seal arranged between the third portion and the pipe when the tool is installed in the hole;
rotating the tool to form the first thread;
rotating the tool to engage the first thread with the second thread; and
engaging the seal between the third portion and an outer surface of the pipe to prevent fluid communication between the gas pipe and an environment in which the tee connection is located.

10. The method of claim 9, wherein the first portion includes a plurality of flutes, each of the flutes having a feature configured to form the first thread.

11. The method of claim 10, wherein each of the flutes tapers from a first end to a second end, the second end being adjacent the second portion, the first end being smaller than the hole.

12. The method of claim 9, wherein the engaging of the seal includes compressing the seal against the outer surface with the third portion.

13. The method of claim 12, wherein the seal is made from an elastomeric material.

14. The method of claim 12, wherein the seal is shaped to create a pressure seal against the outer surface.

15. The method of claim 14, wherein the seal has a conical shape.

16. The method of claim 9, further comprising engaging an installation tool with the feature.

17. The method of claim 16, wherein the feature is at least one of a slot, a threaded hole, or a pair of flat surfaces.

18. A tool for sealing a hole in a pipe, the tool comprising:
a tap portion having a plurality of flutes each of the flutes having a first feature for forming a first thread in the hole;
a threaded portion integral with and extending from the tap portion, the threaded portion having a second thread, the second thread configured to engage the first thread;
a head portion extending from and integral with the threaded portion opposite the tap portion, the head portion having an outer diameter that is larger than the hole and having a second feature configured to engage an installation tool; and
a seal arranged between the head portion and the pipe when the tool is installed in the hole.

19. The tool of claim 18, wherein the plurality of flutes are tapered from a first end opposite the threaded portion to a second end adjacent the threaded portion.

20. The tool of claim 18, wherein the seal is disposed about the threaded portion adjacent the head portion.

21. The tool of claim 20, wherein the seal has an outer surface shaped to form a pressure seal against the pipe.

22. The tool of claim 21, wherein the outer surface has a conical shape.

23. The tool of claim 18, wherein the second feature is one of a slot, a threaded hole, or a pair of planar surfaces.
